(19) United States
(12) Patent Application Publication
(10) Pub. No.: US 2013/0151195 A1
(43) Pub. Date: Jun. 13, 2013

(54) SYSTEM AND METHOD FOR COMPENSATING ORIENTATION OF A PORTABLE DEVICE

(71) Applicant: STMicroelectronics S.r.l., Agrate Brianza (IT)

(72) Inventor: Alberto Marinoni, Milan (IT)

(73) Assignee: STMicroelectronics S.r.l., Agrate Brianza (IT)

(21) Appl. No.: 13/712,605

(22) Filed: Dec. 12, 2012

(30) Foreign Application Priority Data
Dec. 13, 2011 (IT) TO2011A001144

(51) Int. Cl. G01B 7/30

(52) U.S. Cl. CPC G01B 7/30
USPC 702/151

(57) ABSTRACT

A system for compensating orientation of a portable device is provided with a processing unit for: determining a roll rotation angle of the portable device in a mobile reference system associated thereto; and applying a rotation matrix, which is a function of the roll rotation angle, for transforming relative displacements of the mobile device in the mobile reference system into corresponding displacements in a fixed reference system, of an inertial type, thus compensating the orientation of the portable device. The processing unit determines the roll rotation angle, in the presence of dynamic acceleration, by means of: acquisition of a roll angular velocity of the portable device by a gyroscopic sensor fixed with respect thereto; and time integration of the same roll angular velocity.

### BACKGROUND

1. Technical Field

The present disclosure relates to a system and a method for compensating orientation of a portable device (handheld device), such as for pointing applications or the like, in which it is desired to establish a correspondence between movements of the portable device, imparted by a user, and commands to be executed with respect to a fixed reference system (for example, for implementing displacements of a cursor, or similar element, on a screen, or similar element for displaying or representation of information).

2. Description of the Related Art

As is known, there are several applications in which a portable (or handheld) device is used by a user to interact with a user interface of an electronic apparatus, wherein displacements imparted to the portable device by the user are converted into commands for the electronic apparatus by the interface, for example for governing displacements of a cursor or of other images represented on a display screen or, more in general, for generating variations of the graphic operating environment. The portable device is, for example, a controller for videogames, or a three-dimensional (3D) pointer device, to which the following treatment will make particular reference, purely by way of example. It should be noted that by “3D pointing” is meant herein the capacity of identifying movements of the portable device in a three-dimensional space and the corresponding capacity of the user interface to convert these movements into appropriate commands.

In general, the problem inherent in these applications thus includes transforming the path described by an object free to move in a three-dimensional space (the portable device) into displacements to be carried out in a fixed reference system (that of the display screen).

As represented schematically in FIG. 1, two distinct reference systems are hence considered: the first system, the so-called “body frame”, regards a first set of Cartesian axes xₚyₚzₚ of a mobile reference system fixed with respect to the portable device, designated by 1; the second system, the so-called “reference frame”, represents a fixed reference system, of an inertial type and aligned to the acceleration of gravity g, defined by a second set of Cartesian axes xᵥyᵥzᵥ fixed with respect, for example, to a display screen 2 facing in use the portable device 1. Within the mobile reference system the relative movements of the portable device 1 are detected, whilst the fixed reference system constitutes the system in which the same movements are to be carried out or represented. For example, a horizontal axis xᵥ and a vertical axis yᵥ of the fixed reference system define the plane of the display screen 2, onto which the movements of the portable device 1 are transferred, whilst a longitudinal axis zᵥ of the same fixed reference system is aligned to a respective longitudinal axis zₚ of the mobile reference system, and to the direction of pointing of the portable device 1 (which, in general, coincides also with a direction of longitudinal extension of the same portable device 1).

It should be noted that the portable device 1 is illustrated in FIG. 1 in a usual operating orientation, with a top face 1a facing upwards (with respect to the user who is holding it), in such a way, for example, as to orient towards the user appropriate interface elements 3, for example in the form of push-buttons, levers, or similar elements.

In the same FIG. 1 the following magnitudes are moreover designated: the yaw rotation velocity ω_{y} of the portable device 1 about the vertical axis yₚ of the mobile reference system; the pitch rotation velocity ωₚ of the portable device 1 about the horizontal axis xₚ of the mobile reference system; the roll rotation velocity ωᵣ of the portable device 1 about the longitudinal axis zₚ, associated to which is a roll rotation angle φ.

In general, the algorithm implemented considers the two reference systems as coincident as regards the displacements along the horizontal and vertical axes Δx, Δy, applying the following expressions:

Δxᵥ(n)=Δxₚ(n)=Δψ(n)·S=ω_{y}(n)Δt·S (1)

Δyᵥ(n)=Δyₚ(n)=Δθ(n)·S=ωₚ(n)Δt·S (2)

where: ψ is the yaw rotation angle about the vertical axis yₚ; θ is the pitch rotation angle about the horizontal axis xₚ; S is the pointing sensitivity expressed in pixels per degree and indicates by how many elementary units the cursor is to be displaced following upon a one degree rotation of the pointer; and n is the generic n-th sample of the signals detected by a gyroscopic sensor (considering a given sampling interval).

The yaw and pitch rotation angles ψ and θ are detected by integration from the outputs of a gyroscopic sensor, not illustrated, set on board the portable device 1 and configured for detecting the yaw and pitch rotation velocities ω_{y}, ωₚ.

As indicated by the aforesaid expressions (1) and (2), the displacements along the horizontal and vertical axes (Δx, Δy) are ideally irrespective of the orientation of the portable device 1 with respect to its longitudinal axis zₚ, i.e., of the roll rotation angle φ that is imparted on the portable device 1 by the user movements. The rotations of yaw and pitch made by the device within the mobile reference system are consequently transformed into the respective movements along the horizontal and vertical axes xᵥ and yᵥ of the fixed reference system, irrespective of the mutual position between the two reference systems (determined, precisely, by the inclination of the portable device 1 and by the corresponding roll rotation angle φ).

An algorithm of this type hence requires the user to keep the device in the correct orientation so that the movements made will coincide with the displacements performed on the display screen. Any possible rotations of the portable device 1 about its own longitudinal axis zₚ could, in fact, generate a far from intuitive operation on account of the misalignment generated between the two reference systems.

For example, as illustrated schematically in FIG. 2, by applying to the portable device 1 a roll rotation with an angle φ of ninety degrees, a rotation of the mobile reference system with respect to the fixed one is obtained, which brings the horizontal and vertical axes xₚ and yₚ to coincide, respectively, with the axes −yᵥ and xᵥ (the minus sign is determined by the reversal of direction of the vertical axis). In this configuration, and in accordance with the expressions (1) and (2), a yaw rotation applied to the portable device 1 through an angle ψ continues, however, to produce a displacement on the screen in a lateral direction (along the horizontal axis xᵥ), even though in this case it is obtained by moving the device upwards or downwards with respect to the same screen (i.e. parallel to the vertical axis yᵥ). A movement is thus generated in the fixed reference system that is not intuitive and contrary to the expectations of the user. A similar behavior arises for pitch rotations, which produce a displacement on the display screen 2 upwards or downwards in relation to a movement of the portable device 1 performed laterally with respect to the same screen.

In order to overcome this drawback, and to cause the operation of the system to be independent of the rotation of the portable device 1 with respect to the longitudinal axis zₚ, algorithms for roll compensation have consequently been proposed, aimed in general at setting in relation the two reference systems and at rendering the displacements on the display screen 2 dependent also on the device roll rotation angle φ. In brief, the target of the compensation is that of transforming the movements detected within the mobile reference system into absolute movements with respect to the fixed reference system.

Assuming then that the two reference systems are separate and free to rotate with respect to one another, the expressions (1) and (2) are modified as follows:

Δxₚ(n)=Δψw(n)·S=ω_{y}(n)Δt·S (3)

Δyₚ(n)=Δθ(n)·S=ωₚ(n)Δt·S (4)

Δxᵥ(n)∝[Δxₚ(n),Δyₚ(n)] (5)

Δyᵥ(n)∝[Δxₚ(n),Δyₚ(n)] (6)

Expressions (3) and (4) hence again make it possible to derive the displacements in the horizontal plane in the mobile reference system, however requiring a further transformation to obtain the respective co-ordinates in the fixed reference system, corresponding to the display screen 2, as highlighted by the generic relations of proportionality (5) and (6).

The displacement vectors Δxₚ and Δyₚ (referred to the co-ordinates acquired with respect to the mobile reference system) are hence projected in the fixed reference system by rotating them by an amount equal to the roll rotation angle φ that the portable device 1 performs about its own longitudinal axis zₚ. The issue is thus that of a trigonometric change of coordinates, which can be solved by applying a rotation matrix to the coordinates of movement of the portable device 1.

A rotation matrix in the 3D space has 3×3 dimensions and yields the orientation of one Cartesian triad with respect to another. The column vectors that define this matrix represent the directional cosines of the axes belonging to the triad that is rotated with respect to the starting triad. The rotation matrix is given by the following expression:

$${Rz}_{p} ( ϕ ) = [ \begin{matrix}cos ϕ & sen ϕ & 0 \\ - sen ϕ & cos ϕ & 0 \\ 0 & 0 & 1\end{matrix} ] \qquad ( 7 )$$

and describes a generic rotation through an angle equal to φ with respect to the longitudinal axis zₚ.

The rotation matrix Rzₚ(φ) sets in relation the fixed reference system, designated by Δᵥ, with the mobile reference system, designated by Δₚ, by the following relation:

Δᵥ=Rzₚ(φ)·Δₚ (8)

$$[ \begin{matrix}Δ {x}_{v} \\ Δ {y}_{v} \\ 1\end{matrix} ] = [ \begin{matrix}cos ϕ & sen ϕ & 0 \\ - sen ϕ & cos ϕ & 0 \\ 0 & 0 & 1\end{matrix} ] \cdot [ \begin{matrix}Δ {x}_{p} \\ Δ {y}_{p} \\ 1\end{matrix} ] \qquad ( 9 )$$

or, otherwise expressed,

Δxᵥ=Δxₚ·cos(φ)+Δyₚ·sin(φ) (10)

Δyᵥ=Δxₚ·sin(φ)+Δyₚ·cos(φ) (11)

The coordinate z along the longitudinal axis is not considered by the transformation algorithm in so far as it is not possible to perform movements of the cursor in a direction perpendicular to the plane of the display screen 2 (hence, the change of coordinates is reduced to a two-dimensional rotation transformation in the plane of the screen).

Expressions (10) and (11) fully satisfy the requirements of alignment between the two reference systems and make it possible to derive displacements in the fixed reference system that are independent of the orientation of the portable device 1; for example, it may be readily found that a roll rotation of the portable device 1 through an angle φ of 90° (as illustrated in FIG. 2 described previously) produces an exchange between the horizontal and vertical axes, together with a correction of the respective directions.

FIG. 3 shows a graphic representation of the problem of coordinate transformation between the two reference systems, the mobile and the fixed one, as formalized by Eqs. (10) and (11), where the projections of the axes belonging to the mobile reference system on the triad of the fixed reference system are indicated.

The solution to the problem of roll compensation consequently entails the measurement with sufficient precision of the roll rotation angle φ, i.e., of the angle of relative rotation between the mobile reference system and the fixed reference system. As it is evident also from an analysis of FIG. 3, this is equivalent to determining the angle that is formed between the mobile reference system (in particular the vertical axis yₚ) and the direction of the gravity acceleration so as to be able to subsequently apply the relations of transformation (10) and (11).

A known technique in the field of pointing devices for measurement of the roll rotation angle φ envisages the use of an acceleration sensor as an inclinometer. This technique is based on the fact that, according to the static accelerations measured by the accelerometer, it is possible to determine the angle of inclination of a body fixed with respect thereto. In this case, the system consequently envisages integration in the portable device 1 of an acceleration sensor having three sensing axes, in addition to the gyroscopic sensor normally present for detection of the pitch and yaw rotation angles θ, φ (deriving from which are the displacements Δxᵥ and Δxᵥ, according to the relations (3), (4), (10) and (11)).

FIG. 4 shows a possible orientation of the acceleration sensor, designated by 6, with respect to the mobile and fixed reference systems. In particular, the sensing axes of the acceleration sensor 6 are oriented in such a way as to detect: a first acceleration component aₓ along the horizontal axis xₚ of the mobile reference system; a second acceleration component a_{y} along the vertical axis yₚ of the mobile reference system; and a third acceleration component a_{z} along the longitudinal axis zₚ of the mobile reference system (moreover coinciding with the longitudinal axis zᵥ of the fixed reference system).

By applying suitable trigonometric considerations, the roll rotation angle φ may be determined as a function of the acceleration components detected by the acceleration sensor 6, by the relation

$$ϕ = arc tg ( \frac{{a}_{x}}{\sqrt{{a}_{y}^{2} + {a}_{z}^{2}}} ) \qquad ( 12 )$$

The result obtained from Eq. (12), together with the angular displacements of pitch and yaw deriving from the integration of the angular velocity detected by the gyroscopic sensor, which is also fixed with respect to the portable device 1, hence yields all the elements for a complete solution of the algorithm defined by the expressions (10) and (11), thus enabling also roll compensation for the device.

Even though it enables, at least theoretically, the problem of roll compensation to be overcome, the technique described has, however, certain limitations that do not enable complete exploitation of its advantages.

In the first place, from an examination of Eqs. (10), (11) and (12) it is evident that the determination of the roll rotation angle φ entails execution of mathematical and trigonometric functions that are relatively burdensome from the computational standpoint (a square root, an arctangent, a sine and a cosine), which can cause slowing or drops in performance of the processing unit that governs general operation of the system (determining, for example, slower displacements of the cursor on the display screen 2, thus jeopardizing the immediacy of interaction with the user).

In addition, given the direct dependence of the coordinates of displacement on the display screen 2 obtained by Eqs. (10) and (11), with respect to the values assumed dynamically by the roll rotation angle φ of the portable device 1, it is evident that movement artifacts arise whenever errors are committed in the estimation of the same roll rotation angle φ.

It may be shown that Eq. (12) returns a correct angular value only in the case where the acceleration sensor 6 (and the portable device 1 fixed with respect thereto) is subject just to the static components of acceleration. When the outputs of the acceleration sensor 6 have, instead, a resultant with a modulus different from that of the gravity acceleration, i.e., in the presence of contributions of dynamic acceleration, errors arise due to the inexact determination of the roll rotation angle φ.

The presence of dynamic contributions is, however, intrinsic to the use of the portable device 1 by a user, for example for pointing applications, in so far as they occur whenever the device is subjected to vibrations or displacements imparted by the user for performing the movement of the cursor on the display screen 2.

In the presence of dynamic components of acceleration, Eq. (12) has to be rewritten as follows (where the static components, indicated with the subscript ‘s’ and the dynamic components, indicated with the subscript ‘d’, of the acceleration, are rendered explicit):

$$ϕ = arc tg ( \frac{{a}_{xs} + {a}_{xd}}{\sqrt{{( {a}_{ys} + {a}_{yd} )}^{2} + {( {a}_{zs} + {a}_{zd} )}^{2}}} ) \qquad ( 13 )$$

As it has been mentioned previously, Eq. (13) requires, as a condition for returning a correct angular result, that the following further relations be verified (i.e., that the presence of a static condition is verified):

aₓₛ²+a_{ys}²+a_{zs}²= (14)

a_{xd}=a_{yd}=a_{zd}=0 (15)

FIG. 5 shows, by way of example, the effect of the presence of a dynamic component of acceleration a_{xd} along the horizontal axis xₚ of the mobile reference system associated to the portable device 1, which is assumed to be in a horizontal position (i.e., with the top face 1a oriented upwards and substantially parallel to the ground) and subjected by the user to a yaw rotation velocity ω_{y} in order to perform a displacement of the cursor on the display screen 2 along the horizontal axis xᵥ.

Assuming initially the absence of dynamic components of acceleration, the acceleration sensor 6 integrated in the portable device 1 measures the gravity acceleration g as the only component of acceleration in the positive direction of the vertical axis yₚ.

In these conditions, the static and dynamic accelerations are such as to satisfy the relations (14) and (15), determining a roll rotation angle φ consistent with the actual positioning of the system

$$ϕ = arc tg ( \frac{{a}_{xs}}{\sqrt{{a}_{ys}^{2} + {a}_{zs}^{2}}} ) = arc tg ( \frac{0}{1} ) = 0 \qquad ( 16 )$$

In other words, Eqs. (10) and (11) do not determine any correction of the coordinates of displacement of the cursor, given the absence of roll contribution.

Instead, in the case where the portable device 1 is subjected by the user to a mixed movement, yaw rotation plus linear translation, in the positive direction of the horizontal axis xₚ, the accelerometer detects a dynamic component of acceleration a_{xd}, which alters the result of the operation of roll compensation; in fact, Eq. (16) has in this case to be rewritten as follows:

$${ϕ}^{′} = arc tg ( \frac{{a}_{xd}}{{a}_{ys}} ) = arc tg ( \frac{{a}_{xd}}{1} ) \neq 0 \qquad ( 17 )$$

In this condition, the algorithm determines a fictitious roll rotation of the portable device 1, equal to angle φ′, which, applied to Eqs. (10) and (11), determines an erroneous correction of the coordinates of movement of the cursor on the display screen 2; in particular, in this case the following relations apply:

Δxᵥ=Δxₚ·cos(φ′) (18)

Δyᵥ=Δxₚ·sin(φ′) (19)

As illustrated schematically in FIG. 5, the aforesaid fictitious roll rotation ω′ determines, once projected along the horizontal and vertical axes xᵥ and yᵥ, a diagonal movement of the cursor, here designated by 8, which does not corresponds to an actual modification of the inclination of the portable device 1 (in other words, this behavior corresponds to the behavior that would be obtained if the remote control were really rotated in a counterclockwise direction through the angle ω′).

The fictitious variation of the roll rotation angle ω′ hence determines generation of fictitious displacements of the cursor 8 in directions different from the actual movement of the portable device 1, contributing to rendering the user experience at least far from intuitive.

A possible solution to this problem may be that of applying a lowpass filter to the acceleration signals detected by the acceleration sensor 6 in order to suppress undesirable dynamic components and ideally leave the static components due to gravity.

However, the present Applicant has verified that this solution is not free from drawbacks, in particular on account of the delay introduced by the lowpass filter for extracting just the d.c. component of the signal, which generates a “wake” effect on the display screen, as a result of the application of Eqs. (10) and (11). A better performance in terms of phase delay can be obtained by shifting the cutoff frequency of the filter up a few hertz, but this does not enable components of acceleration at low frequency to be adequately suppressed (for example, dynamic and centrifugal accelerations that derive from rotational movements repeated in time, as discussed hereinafter).

Basically, the present Applicant has verified a solution that envisages the use of an accelerometer sensor, possibly also combined with an appropriate filtering of the signals, may not prove sufficient in a wide range of operating conditions, to provide an adequate compensation of the movement artifacts due to roll rotations of the portable device 1.

For example, the use of a lowpass filter proves far from effective in the case of repetitive rotations made with the purpose of describing a circular path on the display screen 2, as illustrated schematically in FIG. 6.

With reference to FIG. 6, rotational movements of the portable device 1 performed in the plane xₚyₚ in fact generate dynamic and centrifugal accelerations. Dynamic accelerations can be represented by low-frequency sinusoidal signals along the horizontal and vertical axes xₚ and yₚ (designated by a_{xd} and a_{yd}). These sinusoidal signals have the characteristic of being phase-shifted by 90° and have an amplitude proportional to the acceleration with which the aforesaid rotational movement is performed.

By applying Eq. (17), it is possible to estimate the fictitious roll rotation ω′ generated in this example by the dynamic components of the acceleration.

FIG. 7 shows the plots of the fictitious roll rotation ω′ for three different values of the dynamic acceleration associated to the movement of the portable device 1. As may be noted from the plots, repetitive rotational movements determine an effect equivalent to a variable inclination of the portable device 1, which, according to the dynamic acceleration, may assume an amplitude comprised between −90° and +90°. Given the frequency characteristics, these dynamic components of acceleration are difficult to suppress by the filtering techniques that may be commonly used because they are very close to the DC component. Centrifugal accelerations are instead always positive and associated to rotational velocity. A low-pass filter drawback can be experienced in case of constant velocity rotation. In such a case, centrifugal acceleration represents a static acceleration component (DC) that can't be removed using the low-pass filter.

### BRIEF SUMMARY

The present disclosure is directed to a system and a method for compensating orientation of a portable device.

### BRIEF DESCRIPTION OF THE SEVERAL VIEWS OF THE DRAWINGS

For a better understanding of the present disclosure, preferred embodiments thereof are now described, purely by way of non-limiting example, with reference to the attached drawings, wherein:

FIGS. 1 and 2 are schematic illustrations of a portable device for applications of three-dimensional pointing, in different orientations with respect to a display screen;

FIG. 3 is a schematic illustration of a transformation of coordinates between a mobile reference system associated to the portable device and a fixed reference system associated to the display screen;

FIG. 4 shows an acceleration sensor fixed with respect to the portable device of FIGS. 1 and 2;

FIGS. 5 and 6 are schematic illustrations of the effect of dynamic components of accelerations acting on the portable device with respect to the displacements generated on the display screen;

FIG. 7 is a graphic representation regarding the variation of a roll rotation angle for the portable device subjected to the dynamic accelerations of FIG. 6;

FIG. 8 shows a further representation of the portable device, with indicated a roll angular velocity acting on the same portable device;

FIG. 9 is a block diagram of a system for compensating orientation of the portable device of FIG. 8, according to an aspect of the present disclosure; and

FIG. 10 is a flowchart regarding a method for compensating the rotation of roll of the portable device implemented in the system of FIG. 9.

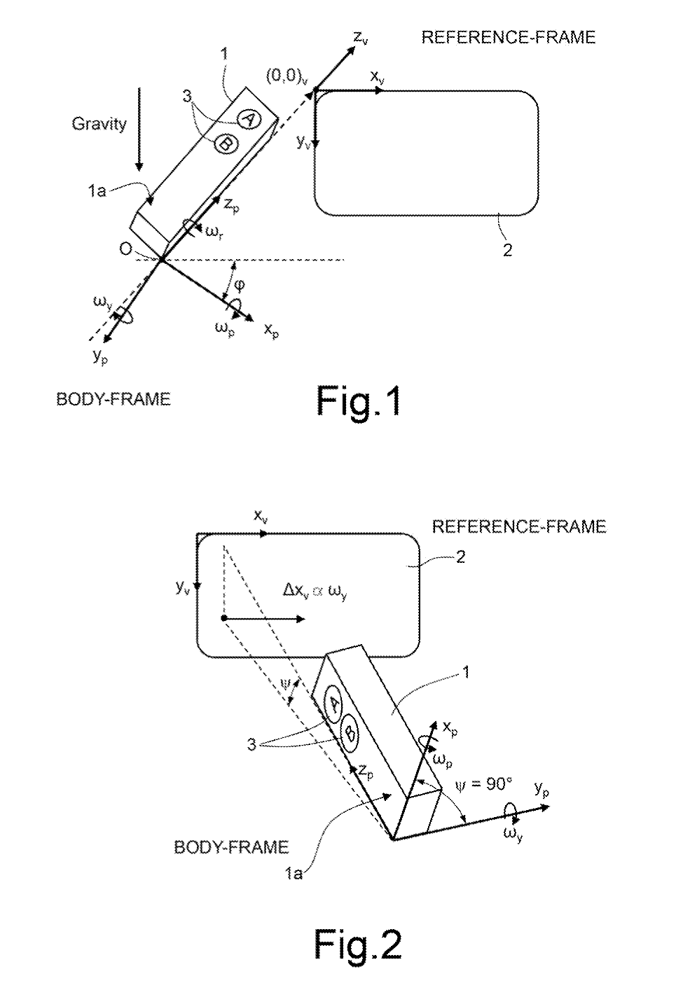

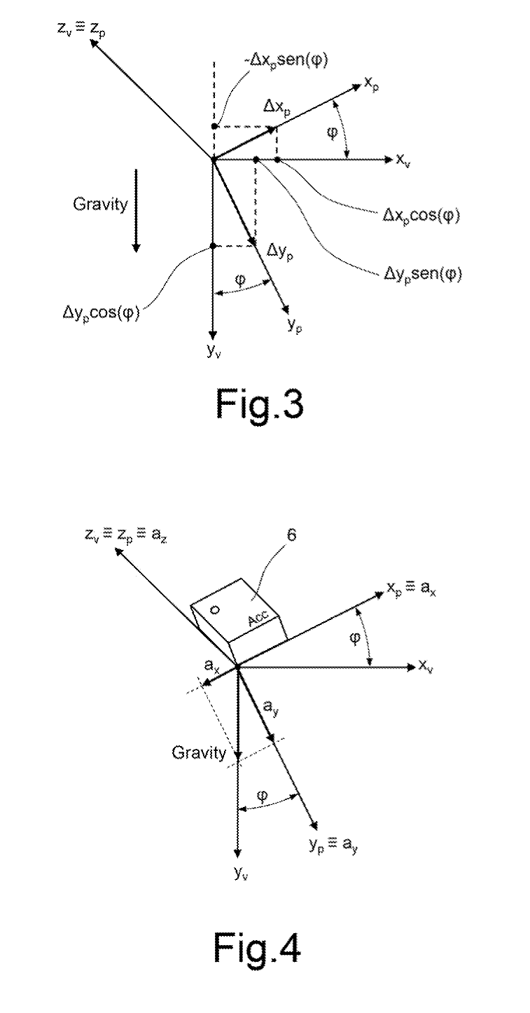

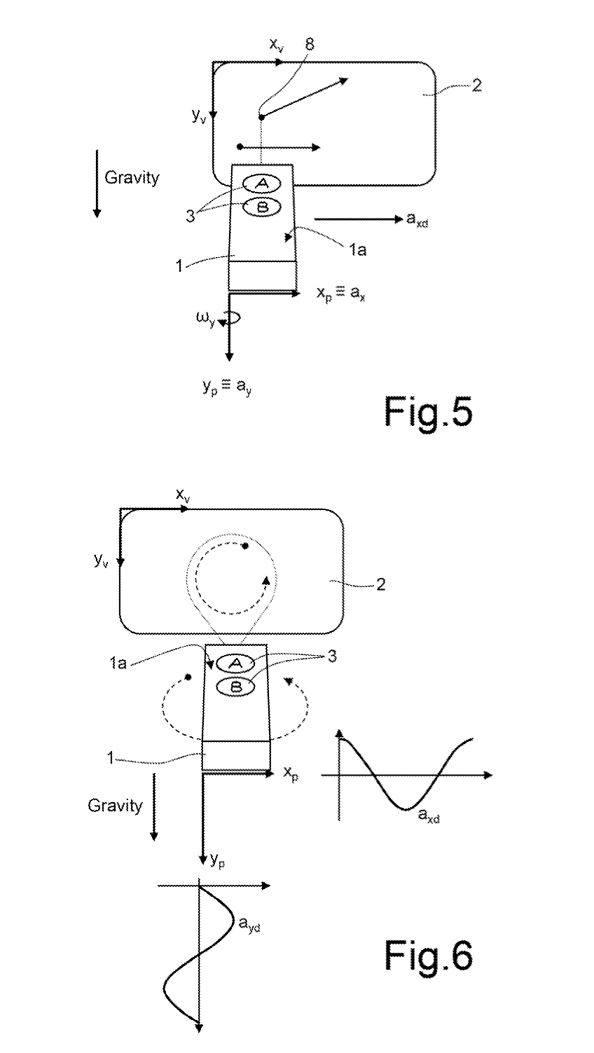

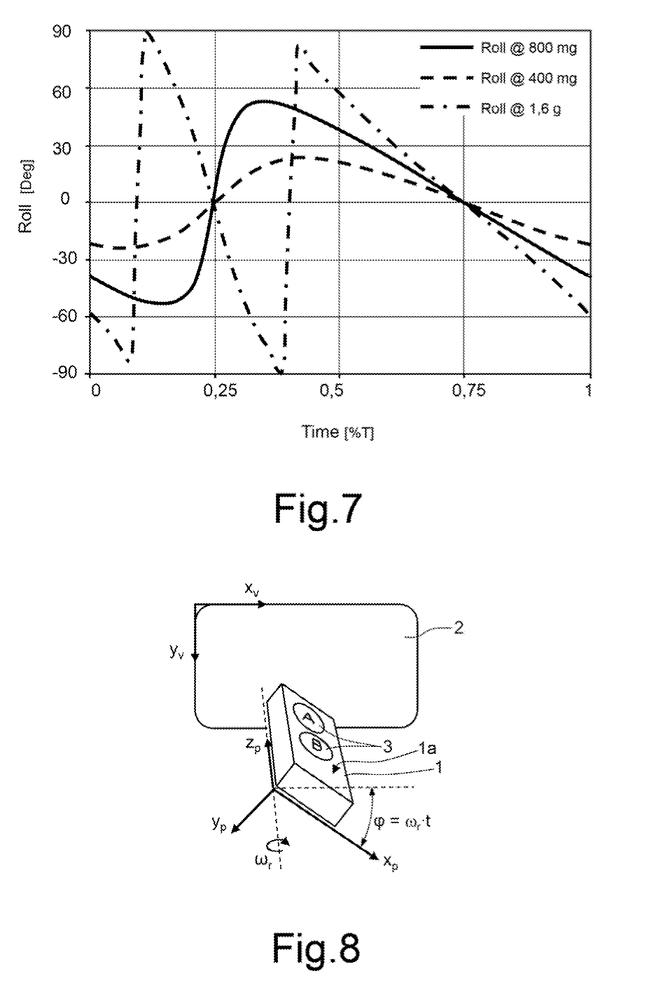

### DETAILED DESCRIPTION

As will be described in detail in what follows, an aspect of the present disclosure envisages, in order to compensate the orientation of the portable device, use of a gyroscopic sensor for determining the roll angular velocity to which the portable device is subjected, and the integration of the roll angular velocity for deriving the roll rotation angle to be used for the compensation operations. These compensation operations may be made in a way similar to what has been described previously with reference to Eqs. (10) and (11), i.e., by using the rotation matrix associated to the roll rotation angle.

As illustrated in FIG. 8 (in general, in this figure and in the subsequent ones, elements that are similar to others already described previously are designated by the same reference numbers), the roll rotation angle, once again designated by φ, is hence derived as a function of the roll rotation velocity ωᵣ of the portable device 1 about the longitudinal axis zₚ, obtained from a gyroscopic sensor having the longitudinal axis zₚ as sensitive axis, in particular by a time integration thereof.

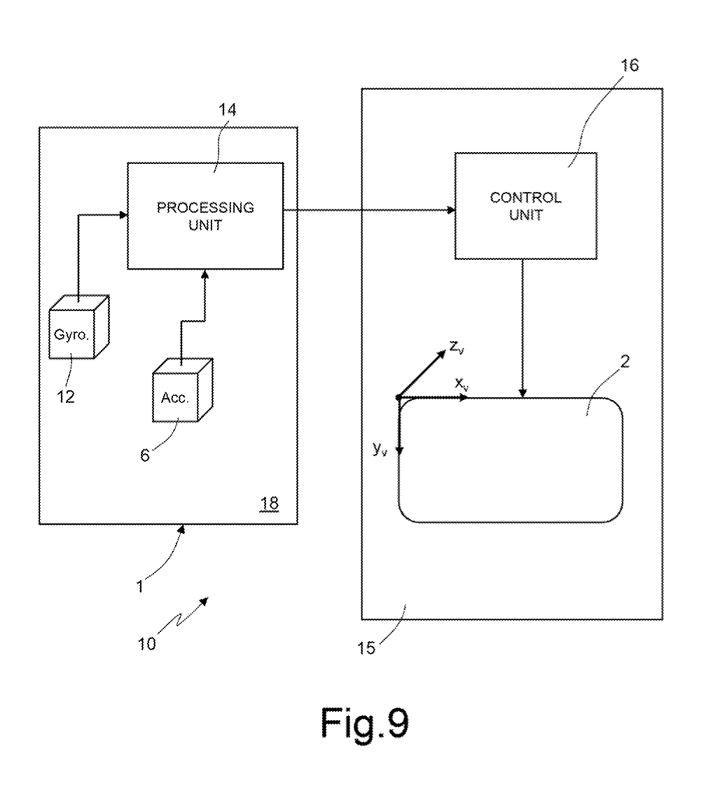

As illustrated schematically in FIG. 9, a system for compensating orientation of the portable device 1, designated as a whole by 10, hence comprises: a gyroscopic sensor 12, in particular including a micro-electromechanical detection structure (MEMS) (of a known type, not described in detail herein) configured so as to determine the yaw rotation velocity ω_{y} of the portable device 1 about the vertical axis yₚ of the mobile reference system associated to the device (see also FIG. 8), the pitch rotation velocity ωₚ of the portable device 1 about the horizontal axis xₚ of the mobile reference system, and the roll rotation velocity ωᵣ of the portable device 1 about the longitudinal axis zₚ. Advantageously, the gyroscopic sensor 12 is hence a triaxial sensor, integrating in a single chip detection of the angular velocity about three sensing axes (alternatively, a number of uniaxial or biaxial gyroscopic sensors may, however, be envisaged).

The compensation system 10 further comprises a processing unit 14, for example including a microprocessor, a microcontroller, an ASIC (Application Specific Integrated Circuit), an FPGA (Field Programmable Gate Array), or similar processing elements, electrically connected to the gyroscopic sensor 12 and configured so as to receive the detected values for the yaw ω_{y}, pitch ωₚ, and roll ωᵣ angular velocities in order to enable determination, as a function of the movements of the portable device 1 in the mobile reference system, of corresponding commands to be imparted in a fixed reference system, for example displacements of a cursor on a display screen 2 associated to an electronic apparatus 15, equipped with a own control unit 16.

In particular, and with reference to what has been illustrated previously, the processing unit 14 is configured for determining the displacements Δxₚ and Δyₚ in the horizontal plane of the mobile reference system by applying Eqs. (3) and (4), and hence determining the corresponding desired displacements Δxᵥ and Δyᵥ to be imparted in the fixed reference system by Eqs. (10) and (11), using the value of roll angular velocity ωᵣ determined by the gyroscopic sensor 12 to determine the roll rotation angle ω, using a numeric-integration method.

Preferably, for the reasons that will be clarified hereinafter, the compensation system 10 further comprises an acceleration sensor, designated once again by 6 and including a respective MEMS detection structure (of a known type, not described in detail herein) configured so as to determine the components of acceleration acting on the portable device 1: aₓ along the horizontal axis xₚ of the mobile reference system, a_{y} along the vertical axis yₚ of the mobile reference system, and a_{z} along the longitudinal axis zₚ of the mobile reference system.

In the embodiment schematically represented in FIG. 9 purely by way of example, the portable device 1 has a housing 18 that encloses inside it, for example coupled to one and the same printed circuit (not shown), the gyroscopic sensor 12, the acceleration sensor 6, and the processing unit 14. In this embodiment, the portable device 1 is able to internally perform the whole processing operations for determining the displacements Δxᵥ and Δyᵥ to be imparted in the fixed reference system, moreover compensating possible roll rotations. The values of displacements Δxᵥ and Δyᵥ may then be transmitted to the control unit 16 of the electronic apparatus 15 by a wireless communication channel of any known type, to be converted by the same control unit 16 into displacements of a cursor on the display screen 3 or into any variation of the graphic operating environment.

It is, however, evident that further embodiments may be envisaged, in which, for example, the algorithm for determining the displacements Δxᵥ and Δyᵥ and for compensating the roll rotation (described in greater detail hereinafter) is executed on board the control unit 16 of the electronic apparatus 15, which receives for this purpose from the processing unit 14 the displacements Δxₚ and Δyₚ in the horizontal plane of the mobile reference system, or, likewise, the yaw and pitch rotation velocities ω_{y}, ωₚ and moreover the roll rotation velocity ωᵣ determined by the gyroscopic sensor 12.

The method for compensating the rotation of roll of the portable device 1 is now described in greater detail, in an exemplary embodiment in which the gyroscopic sensor 12 supplies an output, whether analog or digital, which is sampled by the processing unit 14 with a sampling interval Δt.

The roll rotation angle φ is determined by the following expression, which is the discrete time integral of the roll rotation velocity ωᵣ determined by the gyroscopic sensor 12:

$$ϕ = {ϕ}_{o} + {\sum }_{n = o}^{N} {ω}_{r} ( n ) \cdot Δ t \qquad ( 20 )$$

where φ₀ is an initial value for the roll rotation angle φ.

Eq. (20) hence envisages an iterative computation process, which, at each new sample acquired of the roll angular velocity ωᵣ, updates the value calculated at the previous iteration

φₙ=φₙ₋₁+ωᵣ(n)·Δt (21)

The solution of Eq. (20) hence envisages the knowledge of the sampling interval Δt, of the angular velocity ωᵣ, at each sampling instant n, and of the initial value φ₀; in order to maximize the accuracy of the angular calculation limiting the accumulation of errors that could cause the result of the integration to diverge, a precise control of these parameters is hencedesired.

The sampling interval Δt may be derived directly from the processing unit 14 by an internal timer that enables measurement, for example with the resolution of one microsecond, of the time elapsed between generation of two consecutive data by the gyroscopic sensor 12. This enables limitation of time uncertainties in the computation of the integral, and optimal performance irrespective of the sensor used (and of the corresponding internal clock used for the operations of detection of the angular velocities). In particular, the period of the clock signal of the gyroscopic sensor 12 is factory calibrated in discrete steps with a granularity, for example, of 10%, from which it follows that the frequency of data generation is subjected to a variability of ±5% with respect to a typical design value. If Eq. (20) is solved on the basis of the theoretical sampling time there would thus be the risk of having a systematic error due to the deviation between the set nominal value and the actual frequency of generation of the output samples, and this error would linearly affect the integration time producing a loss of accuracy in the estimation of the roll rotation angle φ, with consequent malfunctioning of the compensation procedure. Advantageously, the use of the internal timer of the processing unit 14 and the dynamic determination of the sampling interval Δt enable prevention of this problem.

The roll rotation velocity ωᵣ is instead derived, in a known way, by converting the output of the gyroscopic sensor 12 by a scale factor, corresponding in general to the nominal sensitivity of the sensor. Even though the value of sensitivity has a given variability from sensor to sensor as a function of a discrete calibration parameter defined in the manufacturing step, and this may involve a possible cause of drifts for the integral operation, the present Applicant has verified the possibility of avoiding integration errors by using the integrated acceleration sensor output, the angular resolution of which can in general be amply sufficient for compensating the rotations of roll in practical use (which are in fact of the order even of a few tens of degrees).

On account of their constructional characteristics, gyroscopes do not enable determination of the third parameter, i.e., the initial value φ₀ of the roll rotation angle φ, which is in fact independent of the angular velocity of the system, given that it is a function of the static orientation of the portable device 1 at the moment when the system is turned on (in practice, when an appropriate supply voltage is supplied to the compensation system 10).

This initial value φ₀ may hence be set in an appropriate way at the start of the procedure (or derived by an external detection system). According to a further aspect of the disclosure, the initial value φ₀ of the roll rotation angle φ is determined by using the acceleration sensor 6, which precisely for this purpose is provided on board the portable device 1. The compensation system 10 hence envisages in this case the presence on board the portable device 1 of a triaxial accelerometer and a gyroscope with three sensing axes, to be used in an appropriate way, according to the environment conditions, for the operations of roll rotation compensation.

As described previously with reference to Eq. (12), the acceleration sensor 6 enables, in fact, correct determination of the roll rotation angle φ in static conditions, i.e., determination of the inclination of the portable device 1 with respect to gravity, when the portable device 1 is not subjected to dynamic components of acceleration. The gyroscopic sensor 12, instead, is used for computing the roll rotation angle φ in dynamic conditions, during movement phases when also a dynamic component is superimposed on the output of the acceleration sensor 6, in addition to the static component.

Moreover, according to a further aspect of the compensation algorithm, the outputs of the acceleration sensor 6, in addition to being used for determining the initial value φ₀, are used also to eliminate possible integration errors and prevent drifts of the integral operation during use of the portable device 1. In particular, during operation, whenever the resultant of the acceleration components along the three axes has a unit modulus, a condition whereby the result yielded by Eq. (12) is considered reliable, the convergence of the integral is imposed to the expected angular value, assessed by the outputs of the acceleration sensor 6. It is thus possible to prevent any offset between the roll rotation angle φ estimated on the basis of the roll angular velocity ωᵣ and the actual orientation of the portable device 1 with respect to the longitudinal axis zₚ.

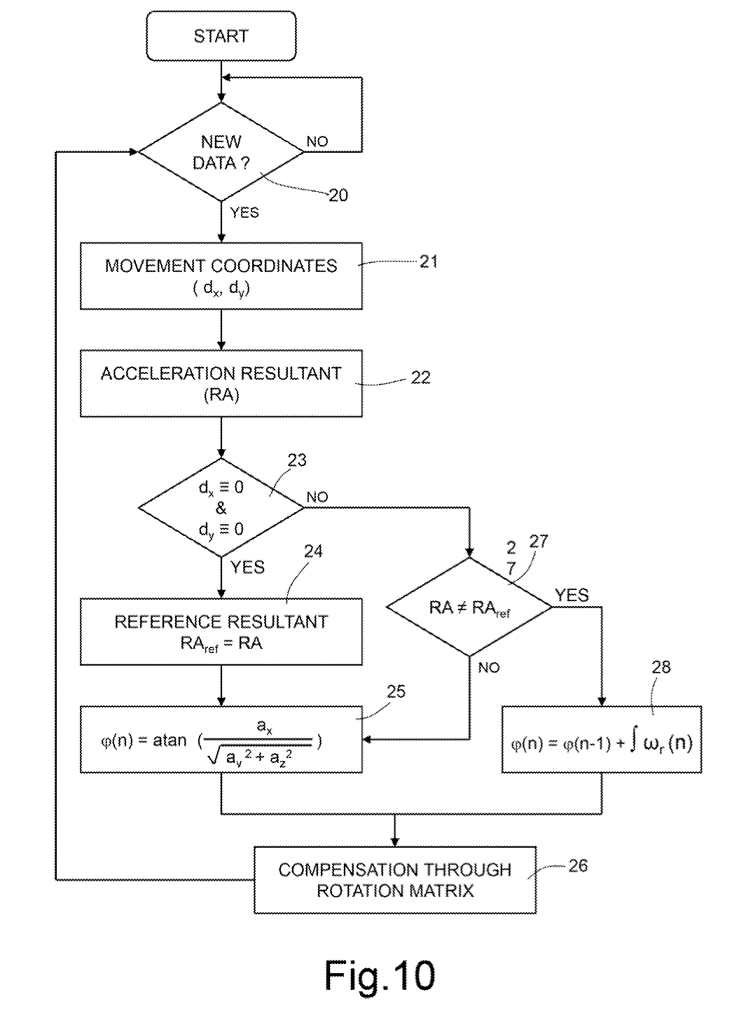

In detail, and with reference to FIG. 10, the algorithm for compensating the rotation of roll hence envisages (step 20) acquisition, at each sampling interval n, of the current data coming from the acceleration sensor 6 and from the gyroscopic sensor 12.

At step 21 the displacements Δxₚ and Δyₚ in the horizontal plane of the mobile reference system are determined via Eqs. (3) and (4) as a function of the previously acquired yaw ω_{y}(n) and pitch ωₚ(n) angular velocities.

At step 22, the resultant RA of the accelerations acting on the portable device 1, which have been acquired in step 20, is determined; in a known way, this resultant is given by the following expression:

RA(n)=\sqrt{aₓ(n)²+a_{y}(n)²+a_{z}(n)²} (22)

At step 23, a check is made to verify the presence of a static condition of the portable device 1, i.e., a condition in which it is assumed that, in the absence of movements in the horizontal plane (displacements Δxₚ and Δyₚ equal to zero, or, in any case, lower than a given threshold), the portable device 1 is subjected to just the gravity acceleration. In the case where the check is successful (output ‘Yes’ from verification block of step 23), step 24 is executed, in which the value of a reference resultant RA_{ref} is updated (or set, in the case of the first iteration of the algorithm) by setting it equal to the current value of the resultant of the accelerations RA(n). It should hence be noted that the reference value for the resultant of the accelerations is calculated on the basis of a direct measurement, thus enabling the solution to be rendered independent of possible offsets of the acceleration sensor 6.

At step 25, where, once the static condition of the portable device 1 has been ascertained, and hence the possibility of implementing roll compensation on the basis of the detected acceleration values, the current value of the roll rotation angle φ is determined by applying Eq. (12), namely

$$ϕ = arc tg ( \frac{{a}_{x} ( n )}{\sqrt{{{a}_{y} ( n )}^{2} + {{a}_{z} ( n )}^{2}}} ) \qquad ( 23 )$$

At step 26, roll rotation compensation is performed, at the same time determining the desired displacements Δxᵥ and Δyᵥ to be imparted in the fixed reference system by Eqs. (10) and (11), using the current value of the roll rotation angle φ(n) previously determined (and the associated rotation matrix).

If, instead, in step 23 the presence of a dynamic (or non-static) condition is determined, i.e., a condition in which the displacements Δxₚ and Δyₚ are not equal to zero, or, in any case, are not lower than a given threshold, from step 23 the algorithm goes to a step 27, in which a further check is made on the value of the acceleration resultant RA.

In particular, if the current value of the acceleration resultant RA(n) is different from the reference resultant RA_{ref}, or deviates from the reference value by more than a given threshold, hence indicating the presence of a condition of dynamic acceleration, from step 27 algorithm goes to step 28, in which the current value of the roll rotation angle φ(n) is determined via integration of the roll angular velocity ωᵣ(n) detected by the gyroscopic sensor 12 and the iterative expression (21).

Advantageously, in this way a correct evaluation of the roll rotation angle φ is obtained, which is to be used for the subsequent determination, once again in step 26, subsequent to step 28, of the desired displacements Δxᵥ and Δyᵥ to be imparted in the fixed reference system, with compensation of the roll rotation.

Instead, in the case where in step 27 it is found that the acceleration resultant RA(n) does not differ from the reference resultant RA_{ref}, or does not deviate from the reference value by more than a given threshold, a condition indicating the absence of dynamic accelerations, the algorithm returns to step 25, in which the current value of the roll rotation angle φ(n) is determined once again on the basis of Eq. (12), by the detected values of acceleration.

In either case, from step 26 the algorithm returns to step 20, for acquisition of new samples of the signals from the acceleration sensor 6 and from the gyroscopic sensor 12.

The advantages of the roll rotation compensation system according to the present disclosure are clear from the foregoing description.

In any case, it is emphasized once again that integration of the roll angular velocity ωᵣ detected by the gyroscopic sensor 12 fixed with respect to the portable device 1 enables the operation of roll rotation compensation to be rendered more effective, in particular in the presence of dynamic accelerations acting on the device.

In addition, the synergistic use of the information detected by the gyroscopic sensor 12 and by the acceleration sensor 6, which is also fixed with respect to the portable device 1, enables implementation of an effective compensation algorithm, preventing errors due to the dynamic acceleration and at the same time drifts or errors of integration of the roll angular velocity ωᵣ.

The solution described may advantageously not need any sensor additional to the ones already normally present on board the portable device 1, hence exploiting a further measurement axis (the roll axis) of the gyroscopic sensor, in any case present for detecting the rotations of yaw and pitch (based on which, in fact, the displacements of the cursor on the display screen are for example determined). The use of a gyroscopic sensor 12 of the triaxial type, as a single component to meet both the needs of pointing and those of roll compensation, proves in this sense advantageous and enables an evident saving in the occupation of space and in the consumption of energy by the system.

In addition, the use of a gyroscopic sensor of a MEMS type proves in itself advantageous, in so far as the micromechanical detection structure is intrinsically, or by construction, insensitive to dynamic disturbance (in particular to acceleration stimuli).

Finally, it is clear that modifications and variations may be made to what has been described and illustrated herein, without thereby departing from the scope of the present disclosure.

In particular, as previously pointed out, the field of three-dimensional pointing represents just one of the possible uses of the compensation system described, which in fact can be used in all the situations in which it is desired to transform movements of a portable device in the three-dimensional space into commands to be imparted in a fixed reference system of an inertial type.

Moreover, it is evident that the same system is likewise suited to a software implementation (in the firmware of the processing unit 14 of the portable device 1 or of the control unit 16 of the electronic apparatus 15 associated thereto), to a hardware implementation (by a provided ASIC), or else to an implementation of a hybrid type.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A system comprising:
a portable device;
a processing unit fixed to the portable device, the processing unit configured to:
perform a first processing operation for determining in a first operating condition a roll rotation angle of the portable device, the first processing operation including acquiring a roll angular velocity of the portable device and determining the roll rotation angle by performing a time integration of the roll angular velocity; and
apply a rotation matrix that is a function of the roll rotation angle, the rotation matrix being configured to transform relative displacements of the portable device in a mobile reference system into corresponding displacements in a fixed reference system, of an inertial type, the corresponding inertial displacements being independent of the orientation of the portable device.

2. The system according to claim 1, comprising a gyroscopic sensor fixed with respect to the portable device and configured to detect the roll angular velocity of the portable device and provide a signal indicative of the roll angular velocity to the processing unit.

3. The system according to claim 2, wherein the gyroscopic sensor is a MEMS triaxial sensor.

4. The system according to claim 1, wherein the processing unit is configured to determine a presence of a dynamic acceleration acting on the portable device in addition to gravity acceleration, as the first operating condition in which to perform the first processing operation for the roll rotation angle.

5. The system according to claim 4, wherein the processing unit is further configured to perform a second processing operation for determining the roll rotation angle in a second operating condition that corresponds to a static condition of the portable device, the second processing operation including:
acquiring acceleration components acting on the portable device along three orthogonal axes of the mobile reference system; and
determining a value of the roll rotation angle as a function of the acceleration components.

6. The system according to claim 5, wherein the processing unit is configured to perform the second processing operation for determining an initial value of the roll rotation angle for time integration of the roll angular velocity.

7. The system according to claim 5, further comprising an acceleration sensor fixed with respect to the portable device and configured to detect the acceleration components acting on the portable device.

8. The system according to claim 5, wherein the mobile reference system comprises a longitudinal axis about which the roll angular velocity of the portable device acts in use, and wherein the processing unit is configured to detect the first operating condition when the corresponding displacements of the portable device along a horizontal axis and a vertical axis of the mobile reference system, orthogonal to the longitudinal axis, are not lower than a first threshold, and a resultant of the acceleration components deviates from a reference value more than a second threshold.

9. The system according to claim 8, wherein the processing unit is configured to dynamically set the reference value to a value of the resultant of the acceleration components detected upon occurrence of the second operating condition.

10. The system according to claim 1, further comprising:
a gyroscopic sensor fixed with respect to the portable device and configured to provide to the processing unit a yaw angular velocity and a pitch angular velocity of the portable device; and wherein the processing unit is further configured to determine the relative displacements of the portable device in the mobile reference system as a function of the yaw and pitch angular velocities.

11. The system according to claim 1, wherein the portable device is a three-dimensional pointer device, and wherein the fixed reference system is associated with a display screen of an electronic apparatus, and the processing unit is configured to carry out corresponding displacements on the display screen as a function of movements of the three-dimensional pointer device.

12. The system according to claim 1, comprising:
a gyroscopic sensor fixed with respect to the portable device and configured to detect the roll angular velocity of the portable device; and
an acceleration sensor fixed with respect to the portable device and configured to detect acceleration components acting on the portable device along three axes of the mobile reference system, wherein the processing unit, the gyroscopic sensor, and the acceleration sensor are housed within a housing of the portable device.

13. A method for compensating for changes in orientation of a portable device, the method comprising:
acquiring a roll angular velocity of the portable device in a mobile reference system associated with the portable device;
determining a roll rotation angle that the portable device rotated by performing a time integration of the roll angular velocity; and
applying a rotation matrix that is a function of the roll rotation angle for transforming relative displacements of the mobile device in the mobile reference system into corresponding displacements in a fixed reference system that is of an inertial type, the corresponding displacements being independent of the orientation of the portable device.

14. The method according to claim 13, comprising determining the presence of a dynamic acceleration acting on the portable device, in addition to a gravity acceleration.

15. The method according to claim 14, wherein determining a roll rotation angle includes performing a first processing operation for determining the roll rotation angle in a first operating condition corresponding to a dynamic condition of the portable device, the method further comprising determining the roll rotation angle in a second operating condition by performing a second operating condition, the second operating condition corresponding to a static condition of the portable device, wherein determining the roll rotation angle in the second operating condition includes:
acquiring acceleration components acting on the portable device along three orthogonal axes of the mobile reference system; and
determining the roll rotation angle as a function of the acceleration components.

16. The method according to claim 15, wherein determining the roll rotation angle in the second operating condition determines an initial value of the roll rotation angle for the time integration of the roll angular velocity.

17. A portable device comprising:
a gyroscope sensor configured to detect a roll angular velocity of the portable device; and
a processing unit coupled to the gyroscope, the processing unit configured to:
receive a signal from the gyroscope indicative of the roll angular velocity of the portable device,
determine a roll rotation angle of which the portable device is rotated by performing an integration of the roll angular velocity, and
transform relative displacements of the mobile device in a mobile reference system into corresponding displacements in a fixed reference system by applying a rotation matrix that is a function of the roll rotation angle, the corresponding displacements being independent of the orientation of the portable device.

18. The portable device according to claim 17, wherein the processing unit is further configured to detect of a dynamic acceleration acting on the portable device in addition to gravity acceleration.

19. The portable device according to claim 17, wherein the fixed reference system is associated with a display screen of an electronic apparatus.

20. The portable device according to claim 17, wherein the gyroscopic sensor is a MEMS triaxial sensor.
